(19) United States
(12) Patent Application Publication
(10) Pub. No.: US 2004/0125080 A1
(43) Pub. Date: Jul. 1, 2004

(54) Extensible type universal remote control and method of operating the same

(75) Inventors: Hoeseong Ha, Suwon-city (KR); Taehyun Ku, Incheon (KR); Jihyun Sun, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/717,469

(22) Filed: Nov. 21, 2003

(30) Foreign Application Priority Data
Dec. 31, 2002 (KR) 10-2002-0087929

(51) Int. Cl. G09G 5/00

(52) U.S. Cl. 345/156

(57) ABSTRACT

An extensible type universal remote control and a method of operating the same is provided, a basic unit of the universal remote control is provided with buttons commonly used for controlling multiple pieces of electronic equipment, and an additional unit detachably connected to the basic unit is provided with additional buttons used only for controlling specific pieces of electronic equipment, so that the number of buttons of the universal remote control can be reduced and the universal remote control can be upgraded to ensure efficient control for new functions added to pieces of electronic equipment. The basic unit also has a remote-control signal transmitting section for transmitting a relevant equipment key code to relevant pieces of electronic equipment; and an extension connection terminal portion formed with data lines for receiving a relevant key code that is generated according to the additional unit.

### BACKGROUND OF THE INVENTION

This application claims priority from Korean Patent Application No. 10-20020087929, filed on Dec. 31, 2002, in the Korean Intellectual Property Office, the disclosure of which is incorporated herein in its entirety by reference.

1. Field of Invention

The present invention relates to a universal remote control, and more particularly, to an extensible type universal remote control and a method of operating the extensible type universal remote control. A basic unit of the universal remote control is provided with buttons commonly used for controlling multiple pieces of electronic equipment. An additional unit is detachably connected to the basic unit, and is provided with additional buttons used only for controlling specific pieces of electronic equipment. Accordingly, the number of buttons of the universal remote control can be reduced and the universal remote control can be upgraded to ensure efficient control for new functions added to pieces of electronic equipment.

2. Description of the Related Art

As remote controls are widely used for the control of pieces of electronic equipment, and as the number of pieces of electronic equipment per home has risen, the number of different remote controls per home has correspondingly increased. Therefore, there is difficulty in managing the different remote controls, and there is also inconvenience in that whenever a user wants to newly select and utilize a piece of electronic equipment, the user is forced to exchange one remote control for another. To solve these problems, there has recently been proposed, in the related art, a universal remote control that allows one remote control to control multiple pieces of electronic equipment.

FIG. 1 is a block diagram showing a configuration of such a universal remote control. The universal remote control comprises a remote-control signal transmitting section 1, a key input section 3 in which a plurality of input selection buttons including an equipment setting button are disposed, a memory section 5 in which information on respective equipment key codes of the input selection buttons is stored, a mode setting section 7 for changing an equipment mode of the universal remote control to a relevant equipment mode according to selection of the equipment setting buttons and a remote-control control section 9. The remote-control control section 9 can control a relevant piece of electronic equipment by first extracting a relevant equipment key code from the memory section 5 and transmitting the extracted key code to the remote-control signal transmitting section 1 according to a selected value of the equipment setting button (e.g., DTV, TV, VCR, CATV and DVD) and a selected value of one of the input buttons selected from the key input section 3. Then, the remote-control signal transmitting section 1 transmits a control signal to the relevant piece of electronic equipment through the remote-control signal transmitting section 1.

However, in the universal remote control described above, the buttons used for specific pieces of electronic equipment, which are not frequently used, are disposed on a front face of the universal remote control along with the buttons commonly used for controlling multiple pieces of electronic equipment. Thus, a problem arises in that the total number of buttons on the front face of the universal remote control is increased, and it is inconvenient for a user to use the universal remote control.

Furthermore, the functions of the buttons disposed on the universal remote control are restricted by a program that has been initially input. Thus, there is a problem in that when new pieces of electronic equipment are added with new functions, or when new functions are added to pieces of existing electronic equipment, these functions cannot be efficiently controlled by the related art universal remote.

### SUMMARY

An object of the present invention is to reduce the number of buttons on a universal remote control by providing a basic unit of the universal remote control with buttons commonly used for controlling multiple pieces of electronic equipment and providing an additional unit detachably connected to the basic unit with additional buttons used only for controlling specific pieces of equipment.

Another object of the present invention is to enable the function of the universal remote control to be infinitely extended by connecting additional units, for respective pieces of electronic equipment, to the basic unit of the universal remote control.

Yet another object of the present invention is to enable new pieces of electronic equipment, or new functions added to existing pieces of electronic equipment, to be efficiently controlled by upgrading information on memory data of the basic unit of the universal remote control as well as the additional units for the respective pieces of electronic equipment.

In order to achieve these objects, an extensible type universal remote control according to an aspect of the present invention comprises a basic unit, said basic unit comprising a key input section comprising common input selection buttons commonly used for controlling multiple pieces of electronic equipment, a remote-control signal transmitting section for transmitting a relevant equipment key code to a relevant piece of electronic equipment, said relevant key code generated according to a selected value of one of said common input selection buttons or a selected value of a specific input selection button arranged outside of said basic unit, and an extension connection terminal portion comprising a data line for receiving the relevant key code when generated by said specific input selection button arranged outside of said basic unit.

Further, a method of operating an extensible type universal remote control according to another aspect of the present invention comprises the steps of connecting the additional unit to the basic unit; selecting a specific input selection button disposed on the additional unit; and transmitting information on a relevant key code, which is generated according to a selected value of the specific input selection button, to a relevant piece of electronic equipment through a remote-control signal transmitting section of the basic unit.

Moreover, a method of operating an extensible type universal remote control according to a further aspect of the present invention comprises the steps of detecting if the additional unit is connected to the basic unit, transmitting an arbitrary key code from the additional unit to a comparison/determination section of the basic unit; comparing information on the arbitrary key code transmitted from the additional unit with information on respective equipment key codes stored in a memory section of the basic unit and determining the arbitrary key code by the comparison/determination section; and automatically changing an equipment mode of the basic unit to an equipment mode corresponding to the arbitrary key code in accordance with the determination result of the comparison/determination section.

Furthermore, a method of operating an extensible type universal remote control according to a still further aspect of the present invention comprises the steps of connecting the additional unit to the basic unit and selecting a specific button among input selection buttons of the additional unit by a user; transmitting a specific key code corresponding to the selected specific button to a comparison/determination section of the basic unit; comparing information on the specific key code transmitted from the additional unit with information on respective equipment key codes stored in a memory section of the basic unit and determining the specific key code by the comparison/determination section; and automatically changing an equipment mode of the basic unit to an equipment mode corresponding to the specific key code in accordance with the determination result of the comparison/determination section.

### BRIEF DESCRIPTION OF THE DRAWINGS

The above and other objects and features of the present invention will become apparent from the following description of exemplary embodiments given in conjunction with the accompanying drawings, in which:

FIG. 1 is a block diagram showing a configuration of a related art universal remote control;

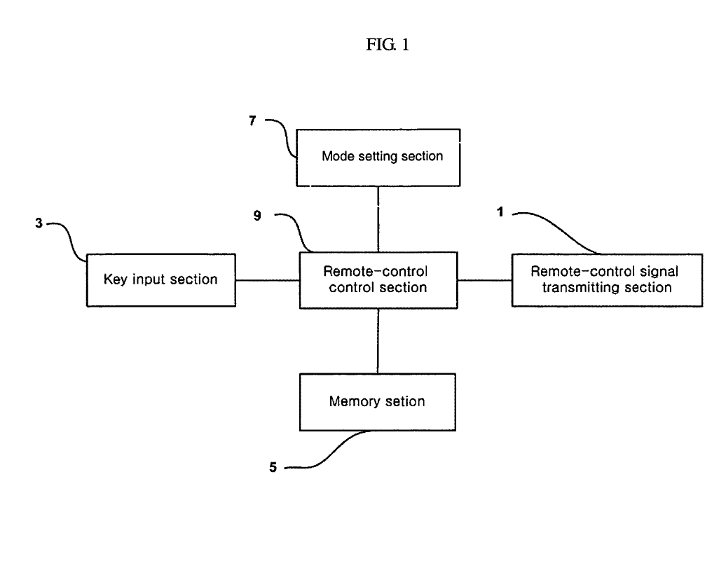

FIG. 2 is a view showing an extensible type universal remote control according to an exemplary embodiment of the present invention;

FIG. 3 is a block diagram showing an exemplary configuration of the extensible type universal remote control according to the present invention;

FIGS. 4(a) to (c) are views showing various exemplary embodiments of the additional unit of FIG. 2;

FIG. 5 is a view showing an exemplary embodiment in which a plurality of additional units are connected to a basic unit of the extensible type universal remote control according to the present invention;

FIG. 6 is a view showing another exemplary embodiment in which a plurality of additional units are connected to the basic unit of the extensible type universal remote control according to the present invention;

FIG. 7 is a flowchart illustrating an exemplary operating process depending on selection of a button in the additional unit of the extensible type universal remote control according to the present invention;

FIG. 8 is a flowchart illustrating an exemplary embodiment of an operating process of automatically changing an equipment mode in the extensible type universal remote control according to the present invention; and

FIG. 9 is a flowchart illustrating another exemplary embodiment of the operating process of automatically changing the equipment mode in the extensible type universal remote control according to the present invention.

### DESCRIPTION

Hereinafter, exemplary embodiments of the present invention will be described in detail with reference to the accompanying drawings. The described exemplary embodiments are intended to assist the understanding of the invention, and are not intended to limit the scope of the invention in any way.

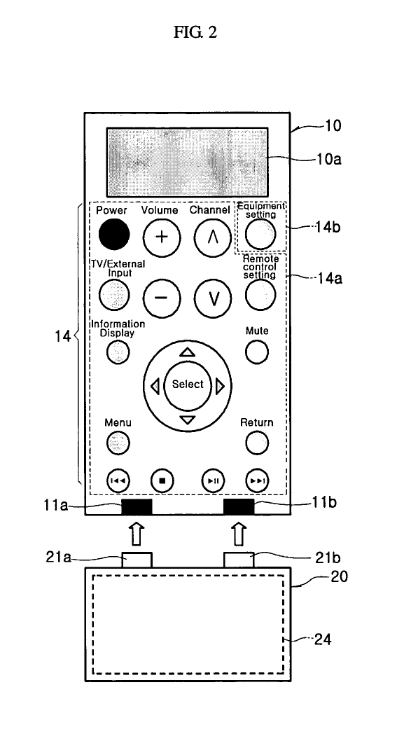

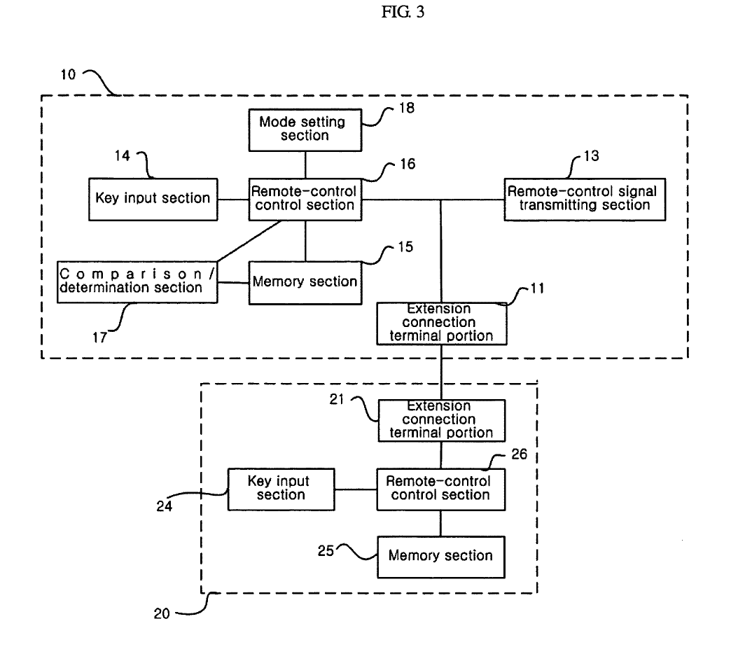

FIG. 2 is a view showing an extensible type universal remote control according to an exemplary embodiment of the present invention. FIG. 3 is a block diagram showing an exemplary configuration of the extensible type universal remote control according to the present invention. This exemplary extensible type universal remote control comprises a basic unit 10, and an additional unit 20 detachably connected to the basic unit 10.

The basic unit 10 includes a remote-control signal transmitting section 13, a key input section 14, a memory section 15, a remote-control control section 16, a comparison/determination section 17, and a mode setting section 18. The basic unit 10 is provided with an extension connection terminal portion 11 on a side thereof and is formed with an LCD window 10a for displaying status information at an upper portion of a front face thereof.

The remote-control signal transmitting section 13 is mounted on an upper end of the basic unit 10 to transmit control signals to pieces of electronic equipment external to the extensible type universal remote control.

In the key input section 14, a plurality of input selection buttons for multiple pieces of electronic equipment are disposed on the front face of the basic unit 10. The input selection buttons include common input selection buttons 14a for controlling multiple pieces of electronic equipment (e.g., a power button, a volume button, a channel button, direction buttons, a selection button and other common buttons), and an equipment setting button 14b for setting electronic equipment to be controlled by the universal remote control (e.g., DTV, TV, VCR, CATV, DVD and the like). Of course, the common input selection buttons 14a are not limited to the buttons shown in the figures. Any buttons commonly used for operating electronic equipment may be utilized as common input selection buttons.

Information on respective equipment key codes of the input selection buttons 14a, 14b of the basic unit and input selection buttons 24a, 24b and 24c of the additional unit (described later) is stored in the memory section 15. For reference, the memory section 15 is composed of a general storage device such as DRAM, SRAM, EEPROM or flash memory. Information on an equipment mode of the universal remote control and information on the input selection buttons may be stored in an additional memory other than the memory in which the respective equipment key codes are stored.

The remote-control control section 16 extracts a relevant equipment key code from the memory section 15 in accordance with a selected value of the equipment setting button 14b and a selected value of the input selection button 14a (selected from the key input section 14) and transmits it to the remote-control signal transmitting section 13. This will be more specifically explained below.

The selected value of the equipment setting button 14b, i.e. the equipment mode of the universal remote control, has been stored in the memory section 15. Upon selection of the equipment setting button 14b, the equipment mode of the remote control is changed to DTV, TV, VCR, CATV, DVD or the like and then stored. For example, if the selected value of the equipment setting button 14b is DVD, the remote-control control section 16 generates a key code for controlling a DVD player in accordance with the selected value of one of the input selection buttons 14a selected from the key input section 14.

The comparison/determination section 17 compares relevant equipment key codes stored in the memory section 15 with a specific key code input from the additional unit 20 to be described later and determines the relevant equipment key code.

The mode setting section 18 automatically changes the equipment mode of the basic unit 10 to a setting mode corresponding to the additional unit 20 in accordance with a determination result of the comparison/determination section 17.

The extension connection terminal portion 11 is a connector connection portion provided at a lower end of the basic unit 10, and includes a data connector connection portion Ha formed with data lines and a power connector connection portion 11b formed with power lines.

The additional unit 20 is provided with an extension connection terminal portion 21, which is detachably connected to the extension connection terminal portion 11 of the basic unit, on a side of the additional unit (e.g., at an upper end thereof). The extension connection terminal portion 21 includes a data connector 21a formed with data lines and a power connector 21b formed with power lines, which are inserted into and connected to the connector connection portions 11a, 11b of the basic unit, respectively. The additional unit 20 also is provided with a key input section 24 in which specific input selection buttons exclusively used for controlling specific pieces of electronic equipment are disposed, a memory section 25 and a remote-control control section 26, and transmits a relevant key code generated according to a selected value of one of the specific input selection buttons to the basic unit 10 through the data lines.

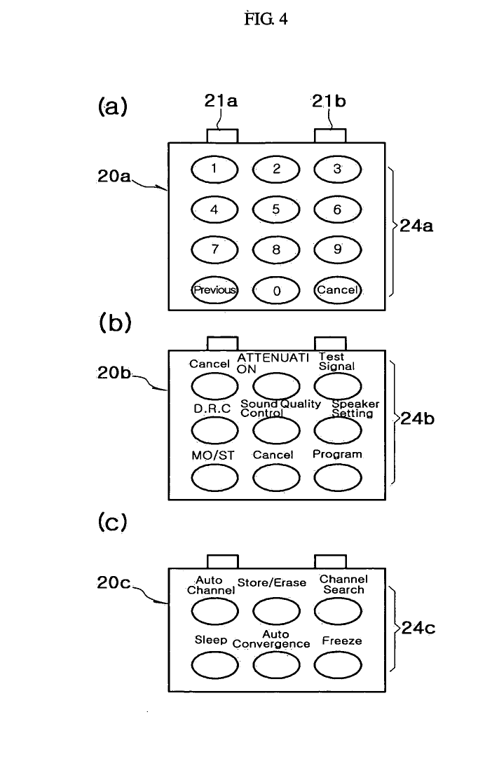

Such an additional unit 20 can be implemented in a variety of examples, such as those exemplary embodiments shown in FIG. 4 (numeric unit 20a, AV unit 20b, or TV unit 20c). However, it will be apparent that the additional unit is not limited to these exemplary embodiments, and can be applied to a variety of different pieces of electronic equipment such as a DVD player unit or a set-top box unit.

In a case where buttons disposed in the key input section 24 of the additional unit (such as the numeric unit 20a, the AV unit 20b or the TV unit 20c shown in FIGS. 4a to 4c) are specific input selection buttons 24a, 24b or 24c exclusively used for controlling specific pieces of electronic equipment, information on relevant key codes of the specific input selection buttons 24a, 24b or 24c is stored in the memory section 25 of the additional unit. The remote-control control section 26 of the additional unit extracts a relevant key code from the memory section 25 in accordance with the selected value of one of the input selection buttons 24a, 24b or 24c selected from the key input section 24 and transmits the extracted key code to the remote-control signal transmitting section 13 of the basic unit 10.

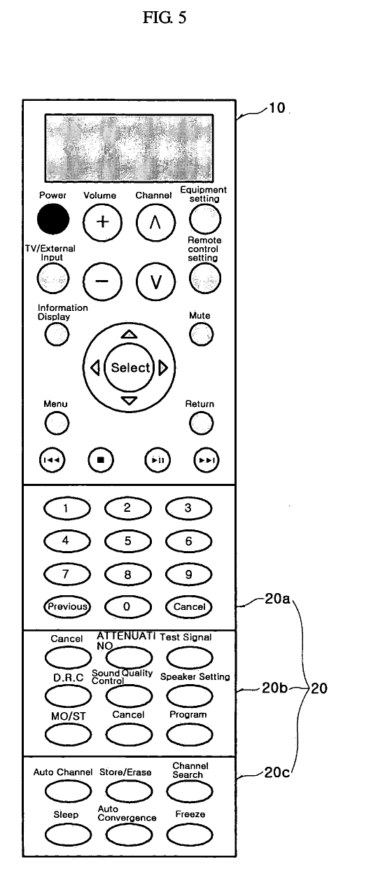

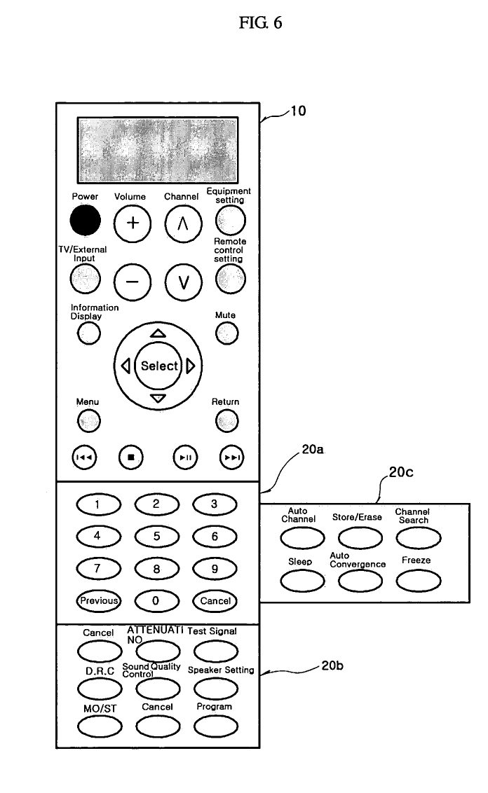

FIGS. 5 and 6 are views showing exemplary embodiments in which a plurality of additional units are connected to the basic unit. As shown in FIG. 5, additional units 20b, 20c are consecutively connected in series to the additional unit 20a connected to the basic unit 10. Alternatively, as shown in FIG. 6, the other additional units 20b, 20c may be connected in parallel to the additional unit 20a connected to the basic unit 10. To this end, each of the additional units in these exemplary embodiments have an extension connection terminal receiving portion (not shown) formed with data lines for receiving relevant key codes input from the other additional units. Meanwhile, although not shown in the figures, the additional units 20 capable of being connected to the basic unit 10 can be consecutively connected to each other, and at the same time, a further additional unit can be connected in parallel to the additional units connected in series. In such a way, the plurality of additional units 20 can be connected to the basic unit 10 of the universal remote control so that the function of the universal remote control can be infinitely extended. Thus, even though a number of pieces of electronic equipment in a home may be increased, all the external equipment can be controlled by a single extended universal remote control.

In such additional units 20, functions of turning on/off power supplied to the respective additional units 20a, 20b and 20c may be controlled by a power source provided in the basic unit 10 through power lines, or by power sources provided in the respective additional units 20a, 20b and 20c which are separate from the power source provided in the basic unit 10.

Meanwhile, although not shown in the figures, an upgrade terminal is provided on a side of the basic unit 10 so that data downloaded through the upgrade terminal can be transmitted to the memory section 15 of the basic unit or the memory section 25 of the additional unit through the data lines, thereby upgrading the information on the key codes in the memory sections 15, 25 of the respective units. Such an upgrade terminal may be an external equipment connection terminal (e.g., a USB terminal), a storage medium mounting terminal (e.g., a smart card terminal), or any other type of terminal capable of allowing data to be downloaded from a storage medium.

An exemplary method of operating the extensible type universal remote control of the present invention will be described as follows.

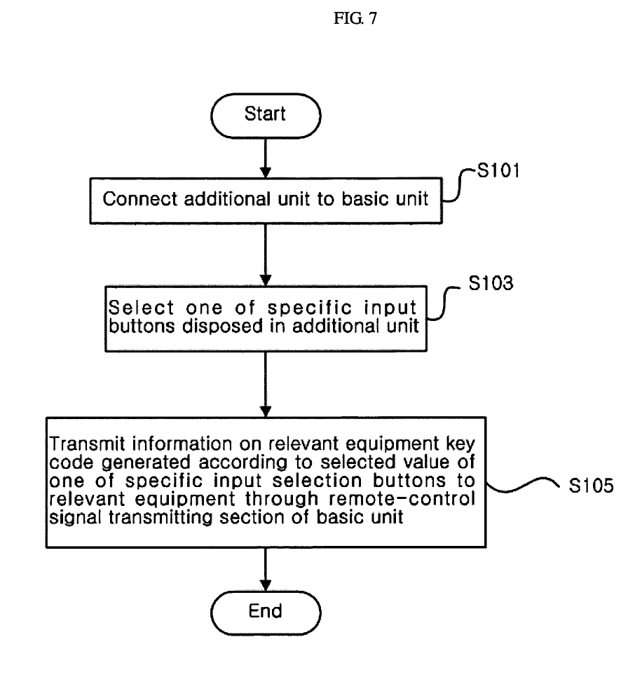

FIG. 7 is a flowchart illustrating such an exemplary operating process, which depends on a selection of a button in the additional unit of the extensible type universal remote control such as that of the exemplary embodiment described above. When a user connects the additional unit 20 for specific pieces of electronic equipment to the basic unit 10 (S101) and selects one of the specific input selection buttons disposed in the additional unit 20 (S103), information on a relevant equipment key code generated according to a selected value of the specific input selection button is transmitted to a relevant piece of electronic equipment through the remote-control signal transmitting section 13 of the basic unit (S105) so that the relevant piece of electronic equipment can be remotely controlled.

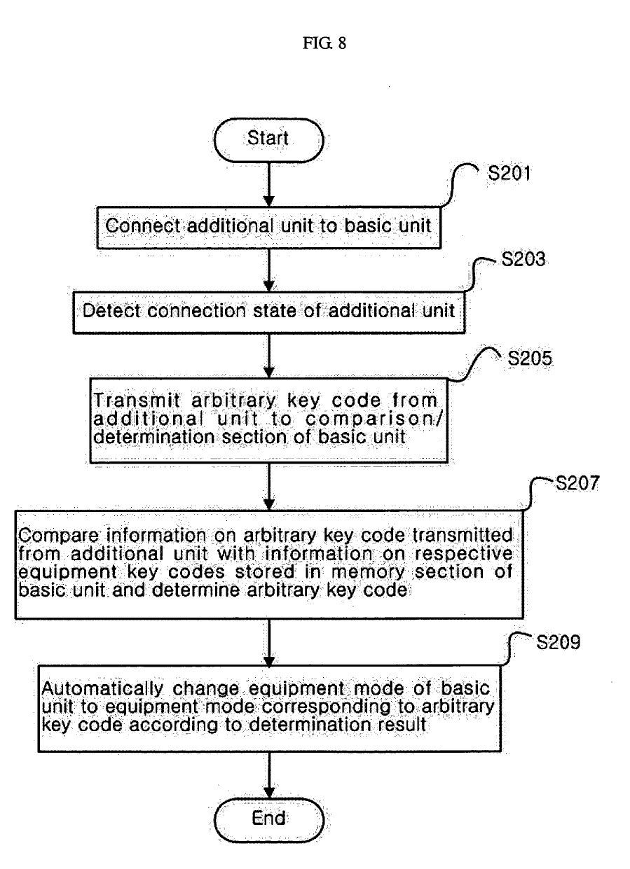

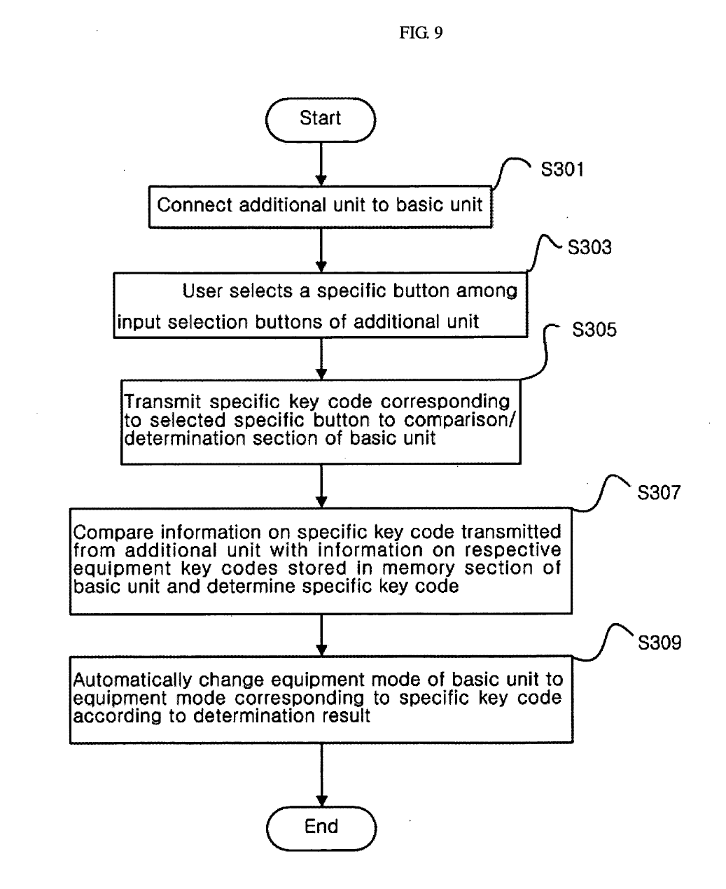

FIGS. 8 and 9 are flowcharts illustrating exemplary embodiments of an operating process of automatically changing the equipment mode in an extensible type universal remote control such as that of the exemplary embodiment described above.

A first exemplary embodiment of such an operating is shown in FIG. 8. If, for example, a TV unit is used as the additional unit 20, and is connected to the basic unit 10 (S201), the remote-control control section 16 of the basic unit detects the connection state of the TV unit (S203) and an arbitrary key code from the TV unit is transmitted to the comparison/determination section 17 of the basic unit (S205). The comparison/determination section 17 compares information on the arbitrary key code transmitted from the TV unit with information on respective equipment key codes stored in the memory section 15 of the basic unit and determines the key code (S207). According to the determination result, the mode setting section 18 automatically changes the equipment mode of the basic unit 10 to a relevant equipment mode corresponding to the arbitrary key code transmitted from the TV unit, i.e. a TV unit mode (S209).

Another exemplary embodiment of such an operating process is shown in FIG. 9. If, for example, a TV unit is used as the additional unit 20, and is connected to the basic unit 10 (S301) and the user selects a specific button among the input selection buttons of the TV unit (S303), a specific key code corresponding to the selected specific button is transmitted to the comparison/determination section 17 of the basic unit (S305). The comparison/determination section 17 compares information on the specific key code transmitted from the TV unit with the information on the respective equipment key codes stored in the memory section 15 of the basic unit and determines the specific key code (S307). According to the determination result, the mode setting section 18 automatically changes the equipment mode of the basic unit 10 to a relevant equipment mode corresponding to the specific key code transmitted from the TV unit, i.e. the TV unit mode (S309).

According to the extensible type universal remote control of the present invention described above, each embodiment yields one or more of the following effects.

First, there is an advantage in that the basic unit of the universal remote control is provided with the buttons commonly used for controlling multiple pieces of electronic equipment, and the additional unit detachably connected to the basic unit is provided with additional buttons used only for controlling specific pieces of electronic equipment so that the number of buttons of the universal remote control can be reduced, resulting in convenience of use of the universal remote control.

Second, there is an advantage in that the function of the universal remote control can be infinitely extended by connecting the additional units for respective pieces of electronic equipment to the basic unit of the universal remote control, and thus, even though the amount of pieces of electronic equipment is increased, all the pieces of electronic equipment can be controlled by the single extended universal remote control.

Third, there is an advantage in that data downloaded through the upgrade terminal provided in the basic unit is transmitted to the memory section of the basic unit or the memory section of the additional unit through the data lines so that information in the memory sections of the respective units can be upgraded, and thus, it is possible to efficiently control new external equipment.

Fourth, there is an advantage in that the universal remote control of the present invention is inexpensive and rigid as compared with a conventional touch screen type universal remote control.

Although the extensible type universal remote control and the method of operating the extensible type universal remote control have been described with reference to the drawings, the present invention is not limited by the embodiments and the drawings. It will be apparent that those skilled in the art can make various modifications and changes within the technical spirit and scope of the invention.

What is claimed is:

1. An extensible type universal remote control comprising:
a basic unit, said basic unit comprising:
a key input section comprising common input selection buttons commonly used for controlling multiple pieces of electronic equipment;
a remote-control signal transmitting section for transmitting a relevant equipment key code to a relevant piece of electronic equipment, said relevant key code generated according to a selected value of one of said common input selection buttons or a selected value of a specific input selection button arranged outside of said basic unit; and
an extension connection terminal portion comprising a data line for receiving the relevant key code when generated by said specific input selection button arranged outside of said basic unit.

2. The extensible type universal remote control as claimed in claim 1, further comprising:
an additional unit, said additional unit comprising:
a key input section comprising the specific input selection button, which is exclusively used for controlling specific pieces of electronic equipment; and
an extension connection terminal portion detachably connected to the extension connection terminal portion of the basic unit and comprising data lines for transmitting the relevant key code, generated according to the selected value of the specific input selection buttons of the additional unit, to the basic unit.

3. The extensible type universal remote control as claimed in claim 2, wherein each of the extension connection terminal portions of the basic and additional units comprises a data connector formed with the data lines and a power connector formed with power lines.

4. The extensible type universal remote control as claimed in claim 1, wherein the specific input selection button is provided on an additional unit, and the basic unit further comprises:
a memory section in which information on the relevant equipment key codes of the input selection buttons of the basic and additional units is stored;
a remote-control control section for extracting the relevant equipment key code from the memory section according to the selected value of the input selection button selected from the key input section of the basic unit and transmitting the extracted key code to the remote-control signal transmitting section;
a comparison/determination section for comparing the relevant equipment key codes stored in the memory section with the key code input from the additional unit and determining the relevant equipment key code; and
a mode setting section for automatically changing an equipment mode of the basic unit to an equipment mode corresponding to the additional unit in accordance with the determination result of the comparison/determination section.

5. The extensible type universal remote control as claimed in claim 4, wherein:
the additional unit further comprises an extension connection terminal portion detachably connectable to the extension connection terminal portion of the basic unit; and
when a user connects the extension connection terminal portions of the basic and additional units to each other and selects the specific input selection button of the additional unit, specific key code information corresponding to the selected specific button is compared with the information on the relevant equipment key codes stored in the memory section of the basic unit, and the equipment mode of the basic unit is automatically changed to the equipment mode corresponding to the specific key code in accordance with the determination result.

6. The extensible type universal remote control as claimed in claim 4, wherein
the additional unit further comprises an extension connection terminal portion detachably connectable to the extension connection terminal portion of the basic unit; and
when the extension connection terminal portions of the basic and additional units are connected to each other, a connection state of the additional unit is detected, information on an arbitrary key code transmitted from the additional unit is compared with the information on the respective equipment key codes stored in the memory section of the basic unit and then determined, and the equipment mode of the basic unit is automatically changed to the equipment mode corresponding to the arbitrary key code in accordance with the determination result.

7. The extensible type universal remote control as claimed in claim 2, wherein the additional unit includes:
a memory section in which information on a relevant equipment key code of the specific input selection button is stored; and
a remote-control control section for extracting the relevant equipment key code from the memory section according to the selected value of the specific input selection button and transmitting the extracted key code to the remote-control signal transmitting section of the basic unit.

8. The extensible type universal remote control as claimed in claim 2, wherein there are a plurality of additional units, and each of the additional units has an extension connection terminal receiving portion formed with data lines for receiving relevant key codes input from the other additional units, and the other additional units are consecutively connected in series or parallel to the additional unit connected to the basic unit.

9. The extensible type universal remote control as claimed in claim 1, wherein an upgrade terminal is provided on a side of the basic unit so that data downloaded through the upgrade terminal can be transmitted to a memory section of the basic unit, thereby upgrading information in the memory section of the basic unit.

10. The extensible type universal remote control as claimed in claim 4, wherein an upgrade terminal is provided on a side of the basic unit so that data downloaded through the upgrade terminal can be transmitted to the memory section of the basic unit, thereby upgrading the information on the key codes in the memory section of the basic unit.

11. The extensible type universal remote control as claimed in claim 2, wherein an upgrade terminal is provided on a side of the basic unit so that data downloaded through the upgrade terminal can be transmitted to a memory section of the basic unit and then to a memory section of the additional unit through data lines, thereby upgrading information in the memory sections of the respective units.

12. The extensible type universal remote control as claimed in claim 7, wherein an upgrade terminal is provided on a side of the basic unit so that data downloaded through the upgrade terminal can be transmitted to the memory section of the basic unit and then to the memory section of the additional unit through data lines, thereby upgrading the information on the key codes in the memory sections of the respective units.

13. The extensible type universal remote control as claimed in claim 9, wherein the upgrade terminal is an external equipment connection terminal to be connected to external equipment so that the data can be downloaded therethrough.

14. The extensible type universal remote control as claimed in claim 10, wherein the upgrade terminal is an external equipment connection terminal to be connected to external equipment so that the data can be downloaded therethrough.

15. The extensible type universal remote control as claimed in claim 11, wherein the upgrade terminal is an external equipment connection terminal to be connected to external equipment so that the data can be downloaded therethrough.

16. The extensible type universal remote control as claimed in claim 12, wherein the upgrade terminal is an external equipment connection terminal to be connected to external equipment so that the data can be downloaded therethrough.

17. The extensible type universal remote control as claimed in claim 9, wherein the upgrade terminal is a storage medium mounting terminal for allowing the data to be downloaded from a storage medium mounted thereon.

18. The extensible type universal remote control as claimed in claim 10, wherein the upgrade terminal is a storage medium mounting terminal for allowing the data to be downloaded from a storage medium mounted thereon.

19. The extensible type universal remote control as claimed in claim 11, wherein the upgrade terminal is a storage medium mounting terminal for allowing the data to be downloaded from a storage medium mounted thereon.

20. The extensible type universal remote control as claimed in claim 12, wherein the upgrade terminal is a storage medium mounting terminal for allowing the data to be downloaded from a storage medium mounted thereon.

21. The extensible type universal remote control as claimed in claim 1, said basic unit further comprising an LCD window, for displaying status information, arranged at an upper portion of a front face thereof.

22. The extensible type universal remote control as claimed in claim 1, said common input selection buttons comprising a power button, a volume button, a channel button, direction buttons, or a selection button.

23. A method of operating an extensible type universal remote control comprising a basic unit and an additional unit, comprising the steps of:
connecting the additional unit to the basic unit;
selecting a specific input selection button disposed on the additional unit; and
transmitting information on a relevant key code, which is generated according to a selected value of the selected specific input selection button, to a relevant piece of equipment through a remote-control signal transmitting section of the basic unit.

24. A method of operating an extensible type universal remote control comprising a basic unit and an additional unit, comprising the steps of:
detecting if the additional unit is connected to the basic unit;
transmitting an arbitrary key code from the additional unit to a comparison/determination section of the basic unit;
comparing information on the arbitrary key code transmitted from the additional unit with information on respective equipment key codes stored in a memory section of the basic unit and determining the arbitrary key code by the comparison/determination section; and
automatically changing an equipment mode of the basic unit to an equipment mode corresponding to the arbitrary key code in accordance with the determination result of the comparison/determination section.

25. A method of operating an extensible type universal remote control comprising a basic unit and an additional unit, comprising the steps of:
connecting the additional unit to the basic unit and selecting a specific button among input selection buttons of the additional unit by a user;
transmitting a specific key code corresponding to the selected specific button to a comparison/determination section of the basic unit;
comparing information on the specific key code transmitted from the additional unit with information on respective equipment key codes stored in a memory section of the basic unit and determining the specific key code by the comparison/determination section; and
automatically changing an equipment mode of the basic unit to an equipment mode corresponding to the specific key code in accordance with the determination result of the comparison/determination section.

26. An extensible type universal remote control comprising:
a basic unit, said basic unit comprising:
a key input section comprising common input selection buttons used for controlling multiple pieces of electronic equipment;
remote-control signal transmitting means for transmitting a relevant equipment key code to a relevant piece of electronic equipment, said relevant key code generated according to a selected value of one of said common input selection buttons or a selected value of a specific input selection button arranged outside of said basic unit; and
extension connection terminal means for receiving the relevant key code from said specific input selection button arranged outside of said basic unit.

27. The extensible type universal remote control as claimed in claim 26, further comprising an additional unit, said additional unit comprising:
a key input section comprising a plurality of said specific input selection buttons, which are exclusively used for controlling specific pieces of electronic equipment; and
extension connection terminal means for transmitting the relevant key code generated according to the selected value of said specific input selection button of said additional unit, to the basic unit;
wherein said extension connection terminal means is detachably connected to said extension connection terminal means of the basic unit.

28. The extensible type universal remote control as claimed in claim 27, wherein each of said extension connection terminal portion means of said basic and additional units comprise a data line.

29. The extensible type universal remote control as claimed in claim 27, wherein each of said extension connection terminal portion means of said basic and additional units comprise a data connector formed with the data lines and a power connector formed with power lines.

30. The extensible type universal remote control as claimed in claim 26, wherein the specific input selection button is provided on an additional unit, and said basic unit further comprises:
memory means for storing information on the relevant equipment key codes of the input selection buttons of said basic and additional units,
remote-control control means for extracting the relevant equipment key code from said memory means according to the selected value of said input selection button selected from said key input section of said basic unit and transmitting the extracted key code to said remote-control signal transmitting means,
comparison/determination means for comparing the relevant equipment key codes stored in said memory means with the key code input from said additional unit and determining the relevant equipment key code, and
mode setting means for automatically changing an equipment mode of the basic unit to an equipment mode corresponding to said additional unit in accordance with the determination result of the comparison/determination means.

31. The extensible type universal remote control as claimed in claim 30, wherein
said additional unit further comprises extension connection terminal means detachably connectable to said extension connection terminal means of the basic unit, and
when a user connects said extension connection terminal means of said basic and additional units to each other and selects said specific input selection button of said additional unit, specific key code information corresponding to said selected specific input button is compared with the information on the relevant equipment key codes stored in the memory means of said basic unit, and the equipment mode of said basic unit is automatically changed to another equipment mode corresponding to the specific key code in accordance with the determination result.

32. The extensible type universal remote control as claimed in claim 30, wherein:
said additional unit further comprises extension connection terminal means detachably connectable to said extension connection terminal means of the basic unit, and
when said extension connection terminal means of said basic and additional units are connected to each other, a connection state of said additional unit is detected, information on an arbitrary key code transmitted from the additional unit is compared with the information on the respective equipment key codes stored in the memory section of the basic unit and then determined, and the equipment mode of the basic unit is automatically changed to the equipment mode corresponding to the arbitrary key code in accordance with the determination result.

33. The extensible type universal remote control as claimed in claim 27, wherein said additional unit includes:
memory means for storing information on a relevant equipment key code of said specific input selection button; and
remote-control control means for extracting the relevant equipment key code from said memory means according to the selected value of said specific input selection button and transmitting the extracted key code to said remote-control signal transmitting means of said basic unit.

34. The extensible type universal remote control as claimed in claim 27, further comprising at least one further additional unit consecutively connected in series or parallel to said additional unit connected to said basic unit,
wherein each of said additional units has an extension connection terminal receiving means for receiving relevant key codes input from other additional units

35. The extensible type universal remote control as claimed in claim 34, wherein each of said extension connection terminal portion means of said basic, additional and further additional units comprise a data line.

36. The extensible type universal remote control as claimed in claim 26, said basic unit further comprising upgrade terminal means for downloading data to upgrade said basic unit.

37. The extensible type universal remote control as claimed in claim 29, said basic unit further comprising upgrade terminal means for downloading data to said memory means of said basic unit, thereby upgrading the information on the key codes in the memory means of said basic unit.

38. The extensible type universal remote control as claimed in claim 26, said basic unit further comprising upgrade terminal means for downloading data to upgrade said basic unit and said additional unit.

39. The extensible type universal remote control as claimed in claim 33, said basic unit further comprising upgrade terminal means for downloading data to said memory means of said basic unit and said memory means of said additional unit, thereby upgrading the information on the key codes in the memory means of said basic unit and said additional unit.

40. The extensible type universal remote control as claimed in claim 36, wherein said upgrade terminal means is an external equipment connection terminal to be connected to external equipment so that the data can be downloaded therethrough.

41. The extensible type universal remote control as claimed in claim 37, wherein said upgrade terminal means is an external equipment connection terminal to be connected to external equipment so that the data can be downloaded therethrough.

42. The extensible type universal remote control as claimed in claim 38, wherein said upgrade terminal means is an external equipment connection terminal to be connected to external equipment so that the data can be downloaded therethrough.

43. The extensible type universal remote control as claimed in claim 39, wherein said upgrade terminal means is an external equipment connection terminal to be connected to external equipment so that the data can be downloaded therethrough.

44. The extensible type universal remote control as claimed in claim 36, wherein said upgrade terminal means is a storage medium mounting terminal for allowing the data to be downloaded from a storage medium mounted thereon.

45. The extensible type universal remote control as claimed in claim 37, wherein said upgrade terminal means is a storage medium mounting terminal for allowing the data to be downloaded from a storage medium mounted thereon.

46. The extensible type universal remote control as claimed in claim 38, wherein said upgrade terminal means is a storage medium mounting terminal for allowing the data to be downloaded from a storage medium mounted thereon.

47. The extensible type universal remote control as claimed in claim 39, wherein said upgrade terminal means is a storage medium mounting terminal for allowing the data to be downloaded from a storage medium mounted thereon.

48. The extensible type universal remote control as claimed in claim 26, said basic unit further comprising an LCD window, for displaying status information, arranged at an upper portion of a front face thereof.

49. The extensible type universal remote control as claimed in claim 26, said common input selection buttons comprising a power button, a volume button, a channel button, direction buttons, or a selection button.
